(19) United States
(12) Patent Application Publication
(10) Pub. No.: US 2018/0177208 A1
(43) Pub. Date: Jun. 28, 2018

(54) FOOD PRODUCT PACKAGE

(71) Applicant: MAGIC PRODUCTION GROUP (M.P.G.) S.A., FINDEL (LU)

(72) Inventors: Paolo VACCARELLA, BALDISSERO TORINESE (IT); Enrico PAVESI, ALBA (IT)

(73) Assignee: MAGIC PRODUCTION GROUP (M.P.G.) S.A., FINDEL (LU)

(21) Appl. No.: 15/738,767

(22) PCT Filed: Jun. 30, 2016
(86) PCT No.: PCT/IB2016/053927

§ 371 Date: Dec. 21, 2017

(30) Foreign Application Priority Data
Jun. 30, 2015 (IT) 102015000029139

(51) Int. Cl. A23G 1/54; B65D 85/60

(52) U.S. Cl. CPC A23G 1/545; A23V 2002/00; B65D 85/60

(57) ABSTRACT

Package for a food product comprising an openable container (1) of non-edible material, including in its interior an accessory which is formed by a first (2) and a second (4) half-shell, connected together by mutual engagement means (6), and a single half-shell of edible material (8) or a plurality of half-shells of edible material provided that they are overlapping, associated with only one (2) of the half-shells of said container, the inner surface (20) of said half-shell (8) of edible material or of the innermost of said half-shells of edible material being of a shape substantially corresponding to the outer surface (24) of the half-shell (2) of non-edible material associated therewith, characterized in that the outer surface (30) of said half-shell of edible material (8) and the outer surface of the other half-shell (4) of the container jointly form a symmetrical body with respect to the coupling plane of the respective half-shells, or a symmetrical body with respect to a plane of symmetry of said body perpendicular to the coupling plane.

### BACKGROUND OF THE INVENTION

The present invention relates to a package for a food product of the type comprising an openable container, usually made of plastic material, intended to contain within it an accessory which is a surprise for the consumer, the container being associated with an edible part, particularly a shell of chocolate or the like.

Currently marketed products each comprise two chocolate half-shells, usually welded to each other along the respective facing mouth edges, between which a container of plastic material is interposed; the two half-shells of edible material are packaged in a wrapping of sheet material adhering to the outer surface of the product.

EP 2 252 528 B1 describes a solution in which, to facilitate the opening of the package to access the surprise container, the ovoidal chocolate body is packaged in two flanged half-shells of sheet material which are coupled to each other by the bending and crimping of the flange edges and in which the plane of separation of the chocolate half-shells coincides with the plane of the flanges.

The present invention tackles the problem of providing a package which, after the removal of its packaging wrapping, enables the consumer to have an immediate visual perception of the presence of the container.

A solution to this problem is described in EP 0 951 835 A and EP 1 018 302 A. In the packages described in these documents, the container is equipped with a rib against which bear the mouth edges of two chocolate half-shells which jointly form an ovoidal body which is substantially symmetrical with respect to the plane of said rib, which is visible from the outside after the removal of the wrapping sheet; however, the visibility of the container is rather reduced, being limited to the thickness of the rib.

The present invention provides an alternative solution which provides ample visibility of the non-edible part of the package and simultaneously enables a product to be made which maintains the typical aesthetic characteristics of this type of product, combined with adequate support and protection for the edible part.

### SUMMARY OF THE INVENTION

Thus one object of the invention is a package for a food product having the characteristics defined in the claims below, which form an integral part of the present description.

Further characteristics and advantages of the package proposed by the invention will be apparent from the following detailed description, which refers to the attached drawings, relating to the embodiment which is commonly used, but is not essential and does not limit the scope of the invention, in which the product has an ovoidal configuration.

### BRIEF DESCRIPTION OF THE DRAWINGS

In the attached drawings,

FIG. 1 is an exploded perspective view of a package according to a first embodiment of the invention, in which the container can be produced by thermoforming;

FIG. 2 is an exploded side view of the package of FIG. 1 without the packaging wrapping;

FIG. 3 is a sectional view of a detail, indicated by I in FIG. 2, in which the half-shells forming the container are in a relationship of mutual engagement;

FIG. 4 is an exploded perspective view of a second embodiment of a package according to the invention, without the wrapping, in which the container can again be produced by thermoforming;

FIG. 5 is a cross-sectional view of a package of the type of FIG. 4;

FIG. 6 is an exploded perspective view of a third embodiment of a package according to the invention, without the packaging wrapping, in which the container can be produced by injection moulding;

FIG. 7 is a cross-sectional view of a package of the type of FIG. 6, and

FIG. 8 is a sectional view of another embodiment of the package according to the invention, without the wrapping.

### DETAILED DESCRIPTION OF THE INVENTION

The term “package” as used in the present description denotes an assembly comprising edible and non-edible parts, joined together to form an independent article.

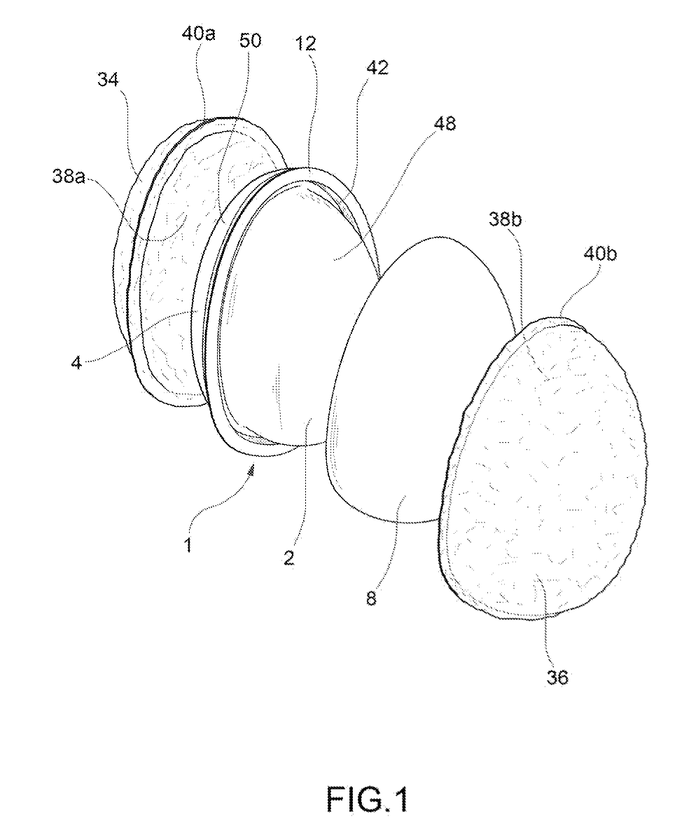

With reference to the drawings, FIGS. 1 to 5 refer to embodiments in which the container can be made by thermoforming from a sheet of plastic material. The package comprises a container 1, typically of plastic material, formed by a first and a second half-shell 2, 4, the mouth profiles of which have mutual engagement means, indicated as a whole by 6, capable of keeping the mouths of the half-shells in a facing relationship. An inner volume intended to receive an accessory or a small toy is formed between the two half-shells.

The container is typically made of plastic material suitable for contact with food, such as polypropylene or propylene-ethylene copolymer, and may be made of opaque or possibly transparent plastic material, if it is desirable for the accessory contained in it to be made visible.

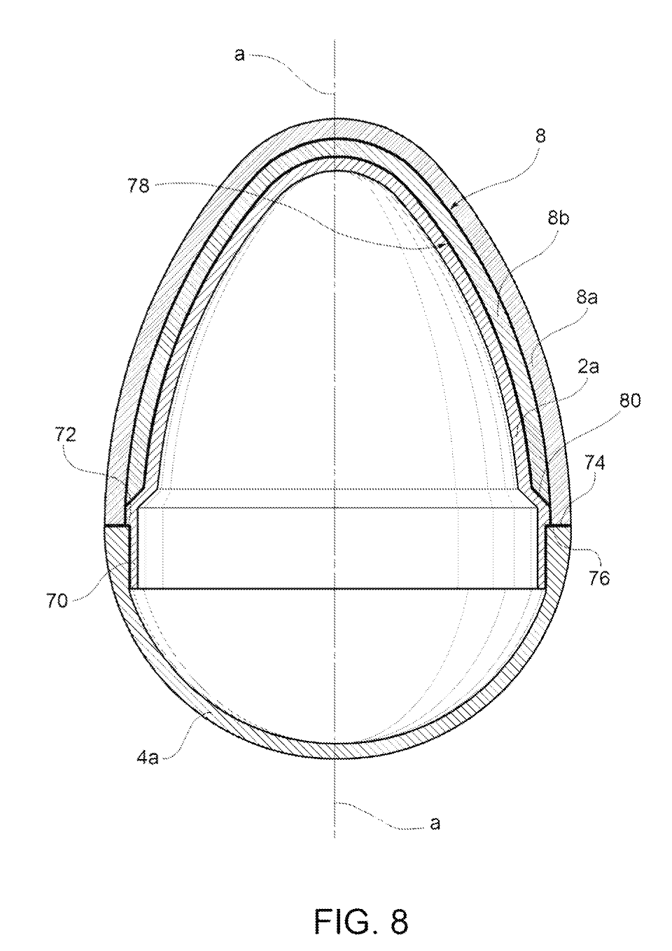

Only one of the half-shells of the container, namely the half-shell indicated by 2 in the drawings, is associated with a half-shell 8 of edible material, typically made of chocolate. This may be a single half-shell, possibly formed by two or more distinct layers, such as a layer of milk chocolate and a layer of milk cream (see, for example, the embodiment in FIG. 8, in which the half-shell of edible material comprises an outer layer 8a (typically made of milk chocolate) and an inner layer 8b (milk cream)), or by two or more separate and distinct half-shells, provided that they are superimposed or can be superimposed on one another, that is to say with the outer surface of the inner half-shell complementary to and in contact with the inner surface of the outer half-shell of the package.

The inner surface of the half-shell 8 of edible material (or, in the case of two or more half-shells 8, the inner surface of the innermost of these half-shells) preferably has a shape substantially corresponding or complementary to the outer surface of the half-shell 2 of non-edible material with which it is associated.

The terms “corresponding” or “complementary” are to be interpreted as referring to the fact that the inner surface of the half-shell of edible material 8 and the outer surface of the container 1 which supports it have the same geometric shape and generally the same dimensions, so that, when the half-shell of edible material is associated with the half-shell of non-edible material, these surfaces are in contact with each other; the terms also refer to the case in which, although these surfaces have the same geometric shape, the inner of the two is of smaller size (or is dimensioned on a smaller scale than the first) so that a gap of substantially constant depth is formed between the two half-shells. This definition is also to be interpreted as including the case in which the outer surface of the half-shell of edible material 8 has a plurality of protruding ribs extending into said gap, where the upper edge of said ribs is in contact with, and supports, the inner surface of the edible half-shell.

The outer surface of the half-shell 8 of edible material, which is in contact with or supported by the outer surface of one of the two half-shells forming the container, forms, together with the other of the two half-shells of the container, a symmetrical body, preferably an ovoidal body with rotational symmetry (but with allowance for minor deviations from rotational symmetry due to any flaring which may be necessary for the extraction of the half-shells from the corresponding manufacturing mould).

This body may be symmetrical with respect to the coupling plane of the two half-shells forming the container (which may be the plane in which the mouth profile of one or both of the half-shells lies) or with respect to a plane parallel to said coupling plane, or may be symmetrical with respect to an axis perpendicular to said coupling plane, or, in particular, in the case of a generally ovoidal configuration, symmetrical with respect to a plane passing through the longitudinal major axis of said ovoidal body.

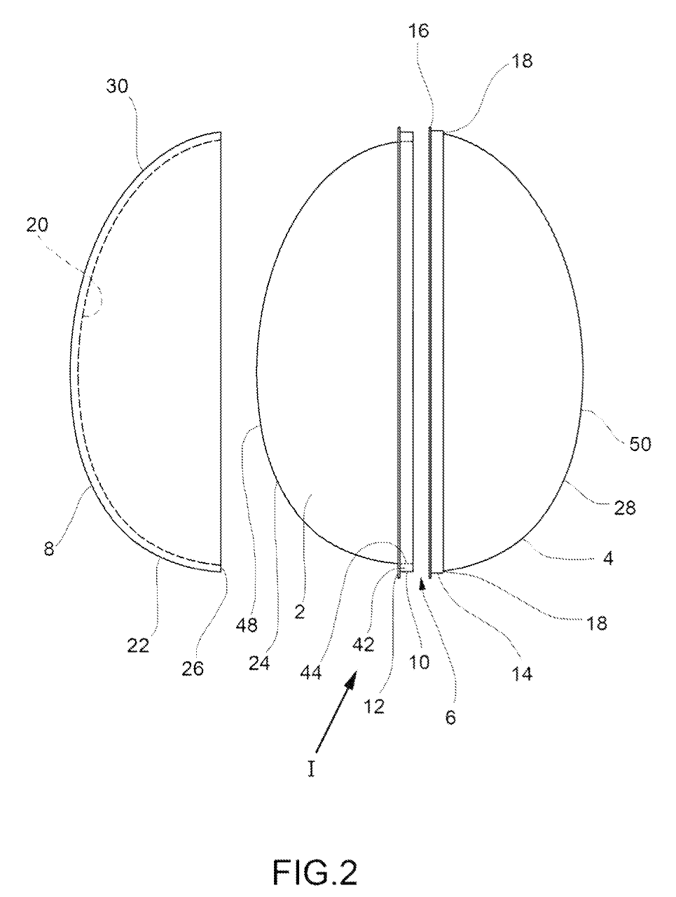

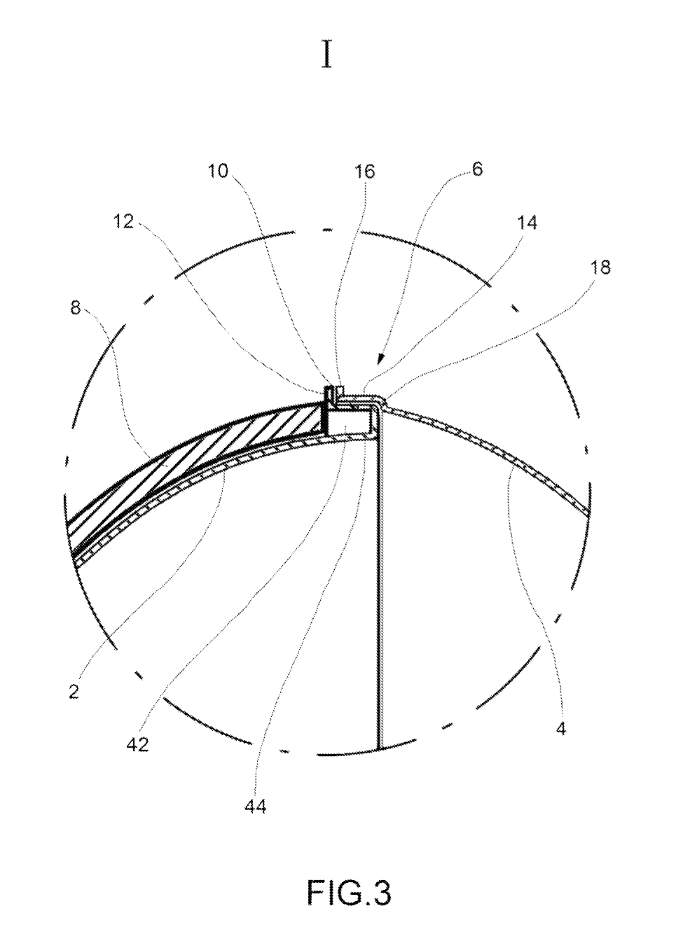

With reference to the shape and structure of the container 1, in the preferred embodiment the two half-shells of non-edible material have a semi-ovoidal configuration, with an ovoidal mouth profile. As can be seen in FIG. 2 and in the detail of FIG. 3, the engagement means 6 between the half-shells of non-edible material comprise a U-shaped upturned terminal portion 10 of the wall of the half-shell of non-edible material 2, with which the half-shell 8 of edible material is to be associated. This upturned wall portion preferably terminates in a substantially flat flange 12, protruding outwards and spaced apart from (placed below) the plane in which the mouth contour of said half-shell 2 lies. The aforesaid engagement means 6 also comprise a terminal portion 14 of the other half-shell 4, which terminates in a substantially flat, outwardly protruding flange 16. The aforesaid terminal wall portion 14 is cylindrical or curved, and is delimited by a shoulder 18 (although this is optional) having a height practically equal to the height of the upturned wall portion 10 of the other half-shell. Thus, in the closed assembled position of the container, the upturned portion 10 is fitted inside the wall portion 14 of the other half-shell, with the flanges 12 and 16 superimposed on each other.

However, the invention is not to be understood as being limited to the specific engagement means described here.

Because of this shaping, the container 1, in the configuration of engagement of its two constituent half-shells, has a body which is generally ovoidal, but non-symmetrical with respect to the coupling plane of the two half-shells, defined as the contact plane between the flanges 12 and 16.

In particular, the concave wall 48 of the half-shell 2 has a semi-ovoidal shape, homologous with the semi-ovoidal shape of the concave wall 50 of the other half-shell 4, but with a mouth contour, defined by the annular edge of the terminal portion 44 of the concave wall 48, smaller than the mouth contour of the wall 50 of the other half-shell 4. The aforesaid mouth contour, defined by the annular edge of the terminal portion 44 of the wall 48, extends parallel to (that is to say, substantially equidistant from) the mouth contour of the wall 50.

The half-shell 8 of edible material (possibly formed by two or more superimposed half-shells, as mentioned above) has a semi-ovoidal wall 22 whose inner surface 20, as mentioned, preferably has a shape corresponding to the outer surface 24 of the half-shell of non-edible material 2.

In the assembled configuration of the package, the annular mouth edge 26 of the half-shell 8 bears against the flange 12 or against a portion of said flange, or, possibly, is inserted into the groove 42 formed by the upturned wall 10 and the terminal portion 44 of the wall of the half-shell 2.

The total wall thickness of the half-shell of edible material 8 (or of a plurality of superimposed half-shells) is such that the outer surface 28 of the half-shell 4 of the container and the outer surface 30 of the half-shell 8 of edible material jointly form an ovoidal body which is symmetrical with respect to the coupling plane of these half-shells, which in the present case is defined by the plane of the flanges 12 and 16. The definition “symmetrical body” is intended to signify that the aforesaid surfaces 28 and 30 are theoretically connectable by an arc with an ovoidal profile (with the possible exception of the wall portion 14).

The aforesaid ovoidal body, formed jointly by the half-shell of edible material and one of the two half-shells of non-edible material, may also be substantially symmetrical with respect to any plane in which the longitudinal major axis of the ovoidal body lies.

It is to be understood that, although the mouth edges of the two half-shells of non-edible material have an ovoidal configuration in the illustrated configuration, the invention is also applicable to the case in which one of the two half-shells forms the pointed end of the ovoidal body and the other forms the rounded base part, and in which the mutually facing annular mouth edges therefore have a circular annular, or possibly elliptical, configuration. In this case also, the single half-shell of edible material (possibly formed by two or more half-shells that can be superimposed) can be coupled to one of the half-shells of non-edible material, namely to the half-shell of non-edible material that has engagement means of the male type; that is to say, in the example of FIGS. 2 and 3, the half-shell 2 with the upturned terminal wall; in this case, the outer surface of the half-shell of edible material forms, together with the outer surface of the half-shell of non-edible material, carrying the female engagement means, an ovoidal body which is symmetrical with respect to a plane of symmetry which, in this case, is perpendicular to the plane of the flanges.

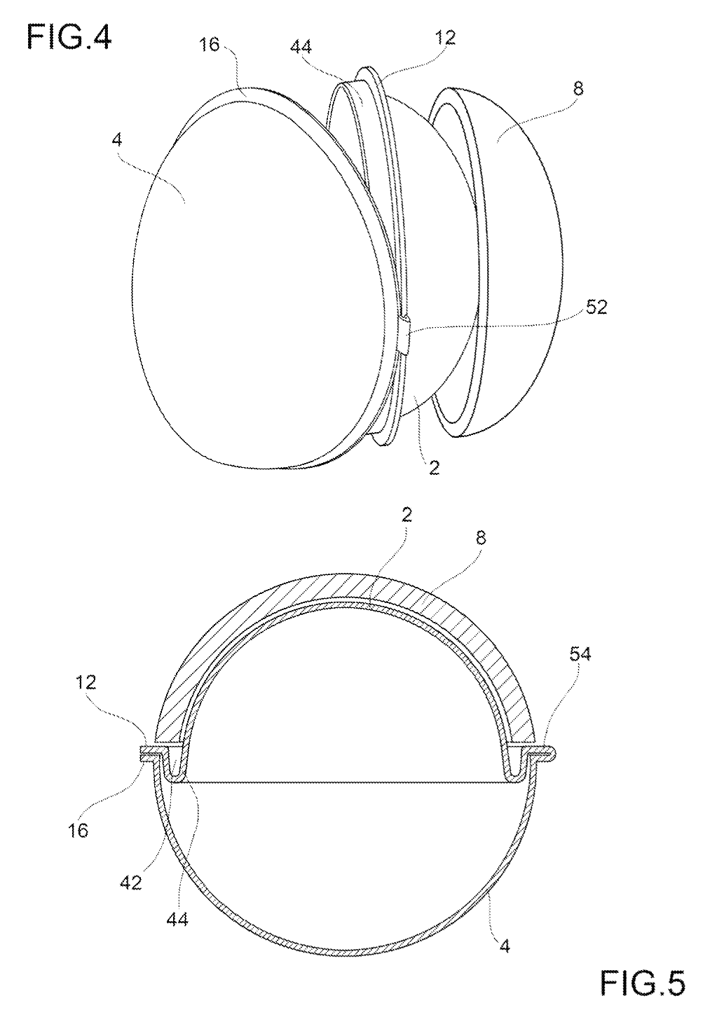

FIGS. 4 and 5, in which parts or elements corresponding to those of FIGS. 1 and 3 are indicated by the same reference numerals, show an embodiment in which the two half-shells 2 and 4, which form the container and can also be produced by thermoforming, are connected to each other by hinge means, indicated as a whole by 52, these means being integral with, that is to say made in one piece with, the two half-shells of non-edible material 2 and 4. In this particular example, the hinge means 52 comprise a film hinge 54 which connects mutually facing portions of the flanges 12 and 16.

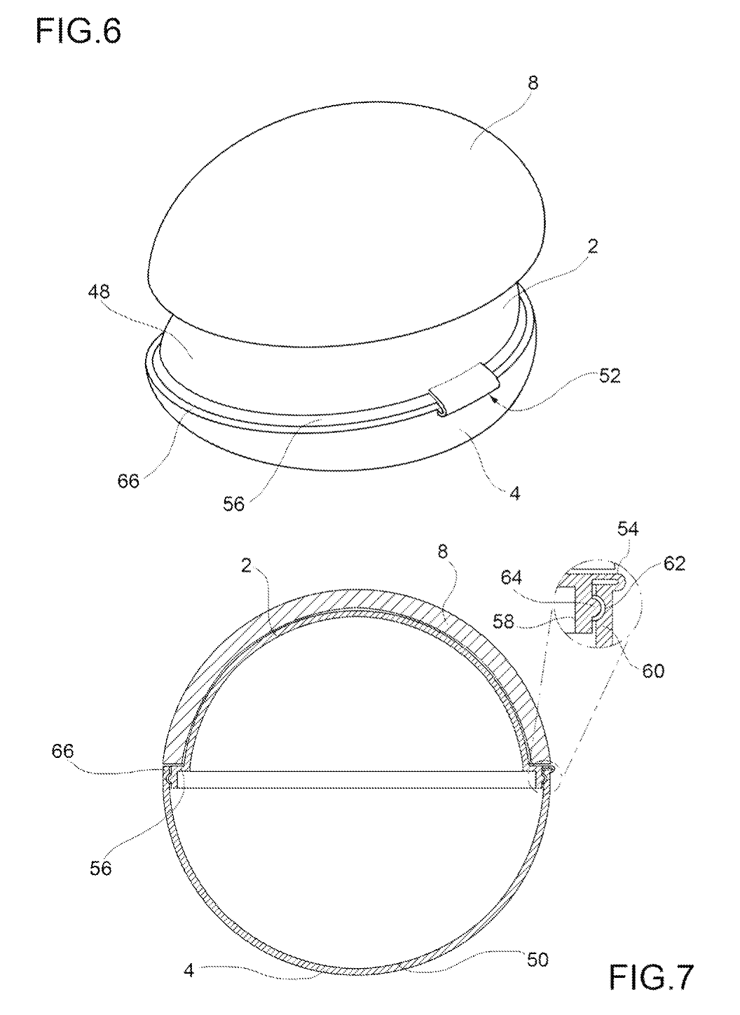

FIGS. 6 and 7 refer to a package in which the container of non-edible material can be made by injection moulding, and which differs from the previously illustrated packages mainly in respect of the formation of the engagement means between the two half-shells.

In these figures also, parts or elements corresponding to those of FIGS. 1 and 5 are indicated by the same reference numerals.

In this example, the half-shell 2 of non-edible material, which supports the half-shell 8 of edible material, has a concave wall 48 surrounded by a substantially flat flange 56, extending outwards, from the end of which there extends a wall portion 58 in the form of a collar. The other half-shell 4 of non-edible material has a concave wall 50 in whose end portion 60 said wall portion in the form of a collar 58 of the half-shell 2 is adapted to engage; the engagement means between the two half-shells therefore comprise said wall portion in the form of a collar 58 and said end portion 60. The aforesaid wall portions may also comprise complementary formations 62 and 64 which can engage with each other by form fit or snap action.

The half-shell of edible material 8 is in a position in which it bears against the flange 56 and against the annular mouth edge 66 of the half-shell 4, and has a thickness substantially equal to the sum of the width of said flange 56 and of the annular mouth edge 66 of the half-shell 4. In this case also, the body formed by the half-shell of edible material 8 and by the half-shell of non-edible material 4 is substantially symmetrical with respect to the coupling plane between said half-shells.

In this case also, the half-shells 2 and 4 may be interconnected by hinge means 52, in particular by means of a film hinge 54 which connects facing portions of the annular mouth edge 66 of the half-shell 4 and of the flange 56 of the other half-shell 2.

FIG. 8 shows an embodiment in which the package has a symmetrical configuration with respect to a plane passing through the longitudinal major axis of the ovoidal shape. In this embodiment, the container of non-edible material is formed by the half-shells 2a and 4a, where the half-shell 2a is the tapered or pointed part and the half-shell 4a is the rounded part.

The half-shell 2a has a terminal cylindrical collar 70 that can engage in the terminal portion (adjacent to the mouth) 72 of the half-shell 4a.

The half-shell 2a has an annular surface 72 which, in the position of engagement of the half-shell 2a with the half-shell 4a, bears against the annular mouth edge 74 of the half-shell 4a.

The portion of edible material of this package comprises the half-shell 8, which in the present case is formed by two superimposed layers 8a (milk chocolate) and 8b (milk cream, for example); the annular mouth edge 74 of the half-shell 8 bears against the annular mouth surface 76 of the half-shell 4a. The inner surface of the half-shell 8 preferably has a shape corresponding (in the sense stated above) to that of the pointed outer surface 78 of the half-shell 2a, and these surfaces are preferably in contact with each other. However, it is also possible to have a configuration in which a gap of substantially constant depth is present between the inner surface of the half-shell 8 and the outer surface of the half-shell 2a (see, for example, FIG. 8, in which the layer indicated by 8b is not present). In this gap there may be spacer ribs, spaced apart angularly (not shown in FIG. 8), which extend between the apex of the pointed end to a point adjacent to or corresponding to the shoulder 80 of the half-shell 2a; the number of these ribs, which have a spacing and engagement function, may be from 2 to 8, for example.

Again with reference to the previously illustrated configurations, the half-shell 4 of non-edible material and the half-shell 8 of edible material are housed in a respective shaped wrapping of sheet material 34, 36, which may be made by using a foil or film of metal, particularly aluminium, or may be formed by joining a metal film to a polymer film, or by using a metal foil or film coated with a heat-sealable lacquer.

Typically, the foils or films used have a thickness of 6 μm to 40 μm, or preferably 8 μm to 20 μm, for example 12 μm. Each wrapping 34 and 36 has a hollow receiving portion 38a, 38b shaped in a substantially corresponding or complementary manner to the outer surface of the respective half-shell of edible material 4 and of non-edible material 8, so as to adhere to this surface, and a peripheral portion 40a and 40b in the form of a flange. The wrappings 34 and 36 are initially associated with the respective half-shell with the flanges 40a, 40b in a superimposed relationship; these flanges are then coupled to one another by bending and/or crimping, thereby forming a disengageable connection between the two wrappings.

Alternatively, the peripheral flange-shaped portions may be interconnected by gluing or welding, which may be performed by providing a heat-sealable lacquer on the facing peripheral surfaces.

After welding, these peripheral portions welded together can be bent back on to themselves and, if necessary, crimped against the outer wall of one of the two wrappings.

In this embodiment, it is preferable for the welding area for providing a hermetic closure of the package, to be provided in a terminal region of the superimposed flange-shaped peripheral portions 40a and 40b, or at least in a region spaced apart from the receiving portion, and for the bending of the flange, in a orthogonal or inclined direction relative to the plane of the superimposed flanges, to be performed along a bending line which does not pass through the welding area, so that this welding area is present in a distal region of the two bent flanges, to avoid damage to the chocolate by the heat emitted from the welding tool. It is to be understood that the aforesaid flange-shaped peripheral portions 40a and 40b, after being bent and crimped, also extend to cover the flanges 12 and 16 of the two half-shells 2 and 4 of non-edible material.

In all the previously illustrated embodiments, it is preferable in all cases for the wrappings of sheet material 34 and 36 to be shaped with an ovoidal mouth profile (see FIG. 1), making it possible to use a pair of shaped wrappings 34 and 36 which are substantially identical to each other, connected to each other by means of the respective flange-shaped peripheral portions, in a median or equatorial plane of the package.

Thus, because of the illustrated characteristics, the invention provides a package in which the container of non-edible material is immediately visible after the removal of the wrapping, and has a configuration which is preferably generally ovoidal, but in any case substantially symmetrical (in the sense indicated above), that is to say a configuration in which the outer surfaces can be joined in a generally ovoidal configuration substantially free of steps.

Clearly, provided that the principle of the invention is retained, the forms of application and the details of implementation can be varied widely from what has been described and illustrated, without departure from the scope of the claims attached below. In particular, the engagement means between the two half-shells forming the container may be formed according to variants of construction known to those skilled in the art; the constructive principle of the package is also applicable to the forming of a package in which one of the two half-shells of the container and the half-shell of edible material jointly form a symmetrical body, in the sense indicated above, which is not necessarily strictly ovoidal.

1. Food product package comprising an openable container (1), including in its interior an accessory, formed by a first (2) and a second (4) half-shell of non-edible material, connected together by mutual engagement means (6) and a single half-shell of edible material (8) or a plurality of half-shells of edible material provided that they are overlapping, associated with only one (2) of the half-shells of said container, the inner surface (20) of said half-shell (8) of edible material or of the innermost of said half-shells of edible material being of a shape substantially corresponding to the outer surface (24) of the half-shell (2) of non-edible material associated therewith, characterized in that the outer surface (30) of said half-shell of edible material (8) and the outer surface of the other half-shell (4) of the container jointly form a symmetrical body with respect to the coupling plane of the respective half-shells, or a symmetrical body with respect to a plane of symmetry of said body perpendicular to the coupling plane.

2. Food product package according to claim 1, characterized in that said engagement means comprise a U-shaped upturned terminal portion (10) of the wall of the half-shell of non-edible material (2), with which the half-shell (8) of edible material is to be associated, and a terminal portion (14) of the other half-shell (4) of non-edible material.

3. Package according to claim 1, characterized in that said U-shaped upturned terminal portion (10) has a substantially flat flange (12) projecting outwards, and said terminal portion (14) of the wall of the other half-shell (4) has a substantially flat flange (16) projecting outwards, said flanges (12, 16) being in an overlapping relationship in the engaged condition of said engagement means (6).

4. Package according to claim 1, characterized in that said half-shell or half-shells (8) of edible material, in the assembled configuration of the packaging, has an annular mouth edge (26) bearing against said flange (12) of said upturned wall portion (10) of the half-shell of non-edible material (2) with which it is associated.

5. Package according to claim 1, characterized in that said half-shell or said plurality of half-shells (8) of edible material has a total wall thickness such that said symmetrical body is formed.

6. Package according to claim 1, characterized in that said container comprises a first half-shell (2) of non-edible material, having a concave wall (48) surrounded by a substantially flat flange (56) from which an end wall portion extends in the form of a collar (58), and a second half-shell (4) of non-edible material, having a concave wall (50) in whose end portion (60) said wall portion in the form of a collar (58) of the other half-shell (2) is adapted to engage, said engagement means (6) comprising said wall portion in the form of a collar (58) and said end portion (60), wherein the half-shell of edible material (8) is in a position in which it bears against said flange (56).

7. Package according to claim 6, characterized in that said engagement means (6) further comprise complementary formations (62, 64), formed in said wall portion in the form of a collar (58) and in said end portion (60), said formations being capable of engagement by form fit or snap action.

8. Package according to claim 6, characterized in that said half-shell of edible material (8) has a thickness substantially equal to the sum of the width of said flange (56) and of the annular mouth edge (66) of said wall (50) of the other half-shell (4).

9. Package according to claim 1, characterized in that said first (2) and second (4) half-shells of edible material are connected to each other by articulation means (52) integral with said half-shells.

10. Package according to claim 1, characterized in that said first (2) and second (4) half-shells are connected to each other by articulation means (52) integral with said half-shells and comprising a film hinge connecting facing portions of said flanges (12, 16).

11. Package according to claim 1, characterized in that said first (2) and second (4) half-shell of non-edible material are connected to each other by articulation means (52) integral with said half-shells and comprising a film hinge (54) connecting facing portions of the annular mouth edge (66) of one of said half-shells and of said flange (56) of the other half-shell.

12. Package according to claim 1, characterized in that it further comprises an outer wrapping of sheet material formed by a first half-shell of sheet material (36) defining a cavity substantially complementary to the outer surface (30) of the half-shell(s) of edible material (8) and a second half-shell of sheet material (34) defining a cavity substantially complementary to the outer surface (28) of the half-shell of non-edible material with which the half-shell of edible material (8) is not associated, said first and second half-shells of sheet material being connected to each other along their respective edges so as to form a closed wrapping.

13. Package according to claim 12, characterized in that said first (36) and second (34) half-shell of sheet material have a peripheral end wall portion (40b, 40a) in the form of a flange, wherein said peripheral portions are interconnected by gluing, welding, bending and/or crimping, or by a combination of gluing or welding with bending and/or crimping.
